(19) United States
(12) Patent Application Publication
(10) Pub. No.: US 2007/0014614 A1
(43) Pub. Date: Jan. 18, 2007

(54) Image forming apparatus and program for outputting error information of image forming apparatus

(76) Inventor: Shigetaka Yoshida, Komaki-shi (JP)

Correspondence Address: MCDERMOTT WILL & EMERY LLP, 600 13TH STREET, N.W., WASHINGTON, DC, 20005-3096, US

(21) Appl. No.: 11/478,354

(22) Filed: Jun. 30, 2006

(30) Foreign Application Priority Data
Jun. 30, 2005 (JP) P2005-191471

(51) Int. Cl. B41J 5/30

(52) U.S. Cl. 400/62

(57) ABSTRACT

An image forming apparatus that comprises: an error history information storing unit; an error history information outputting unit; an error detecting unit that detects an error; an error type determining unit that determines whether an error belongs to the first type error or the second type error; a total print page number counting unit; a total print page number acquiring unit that acquires the total print page number.

### CROSS REFERENCE TO RELATED APPLICATION

This application claims priority from Japanese Patent Application No. 2005-191471, filed Jun. 30, 2005, the contents of which are hereby incorporated by reference into the present application.

### TECHNICAL FIELD

Aspects of the present invention relate to an image forming apparatus such as printer apparatus, facsimile apparatus, scanner apparatus and copy machines, and also relate to a program for outputting an error history of the image forming is apparatus.

### BACKGROUND

Conventional image forming apparatus such as a printer apparatus, a facsimile apparatus, a scanner apparatus and a copy machines, store a detail of an error, which occurred, as an error history. The error history is, for example, referred to when an error happens in an image forming apparatus and is used to track down causes of the error. In such an image forming apparatus, the memory capacity of a storage unit, which stores error histories, is limited for cost reduction. Only limited number (e.g. ten) of errors are stored in the error history. As the limited number is exceeded, error histories are deleted in the order from the oldest to the newest.

Conventional image forming apparatus store all kind of errors as an error history. It is necessary to extract causal error information in order to identify a cause of an error. The error history comprises a lot of errors, for instance, an error of “Cover Open”, which occurs frequently, and an error of “No Paper”, which constantly happens and can be easily recovered. Therefore, critical errors to be extracted are inevitably buried in such errors, so that it has taken a lot of time to find causes. Also, since only a limited number of errors are stored, necessary error information may be deleted at an early stage when a lot of errors are stored. Thus, it is becomes difficult to find causes of error.

Aspects of the present invention provide an image forming apparatus that outputs error history information so that causes of errors can be easily found and a program for outputting error histories of the image forming apparatus.

### SUMMARY

According to an aspect of the present invention, an image forming apparatus comprises: an error history information storing unit that stores error history information generated in a printing processing; an error history information outputting unit that outputs the error history information; an error detecting unit that detects an error, which occurs in the image forming apparatus, to identify a category of an error; an error type setting unit that categorizes plural errors to be detected by the error detecting unit into a first type error to be outputted by the error history information outputting unit or into a second type error not to be outputted by the error history information outputting unit; an error type determining unit that determines whether an error detected by the error detecting unit belongs to the first type error or the second type error, with reference to a setting set by the error type setting unit; a total print page number counting unit that counts a total print page number in the image forming apparatus; a total print page number acquiring unit that acquires the total print page number from the total print page number counting unit, when the first type error is detected; and an error history information storage controlling unit that associates the detected category of the first type error with the acquired total print page number, and stores as error history information in the error history information storing unit. The error history information outputting unit does not output error history information associated with the second type error, and outputs only error history information of the first type error.

According to another aspect of the present invention, a computer program product for enabling a computer to output error information of an image forming apparatus comprising an error history information storing unit that stores error history information generated in a printing processing, and an error history information outputting unit that outputs the error history information, comprises: software instructions for enabling the computer to perform predetermined operations, and a computer readable medium bearing the software instructions; the predetermined operations comprising the steps of: detecting an error by an error detecting unit, the error occurring in the image forming apparatus, to identify a category of an error; categorizing plural errors to be detected by the error detecting unit by an error type setting unit into a first type error to be outputted by the error history information outputting unit or into a second type error not to be outputted by the error history information outputting unit; determining by an error type determining unit whether an error detected by the error detecting unit belongs to the first type error or the second type error, with reference to a setting set by the error type setting unit; counting a total print page number in the image forming apparatus by a total print page number counting unit; acquiring the total print page number from the total print page number counting unit by a total print page number acquiring unit, when the first type error is detected; associating the detected category of the first type error with the acquired total print page number, and storing as error history, information in the error history information storing unit by an error history information storage controlling unit; and not outputting error history information associated with the second type error and outputting only error history information of the first type error by the error history information outputting unit.

### BRIEF DESCRIPTION OF THE DRAWINGS

FIG. 1 is a block diagram showing a printer apparatus of an illustrative aspect of the invention;

FIG. 2 is a schematic view showing a sheet transporting path in the printer apparatus;

FIG. 3 is a flow chart showing a flow of a history customizing program;

FIG. 4 is an explanatory diagram of an external memory;

FIG. 5 is an explanatory diagram of the output setting of error information;

FIG. 6 is a diagram showing an output error as a history set on the basis of the output setting of FIG. 5, and a non-output error;

FIG. 7 is a flow chart showing a flow of a total print page number counting program;

FIG. 8 is a schematic view of a storage table of error history information stored in an external memory;

FIG. 9 is a schematic view of a storage table of error statistics information stored in an external memory;

FIG. 10 is a flow chart showing a flow of an error history outputting program; and

FIG. 11 is a view showing an example of an output form of error information.

### DETAILED DESCRIPTION

General Overview

With such a configuration, it is possible to set the image printing apparatus so that error history information related only to the needed type of error is outputted, and error history information related to the unnecessary type of error is not outputted. Thus, only error types well-selected according to the request of a user or a service person can be outputted, so that causes of errors can be easily tracked down.

In an image printing apparatus according to the present invention, where a total print page counting unit counts up the total print page count after paper feeding, if the first type error occurs in a period of time from the start of the paper feeding to the start of the counting of the total print page counting unit, the error history information storage controlling unit may be configured to store the value of adding 1 to a counted value of the total print page count and the first type error which has occurred, while correlating them with each other, in the error history information storing unit.

When a total print page counting unit counts up the total print page count after paper feeding, counting is not performed from the start of paper feeding until the start of counting, so that the total print page count stays at the value of the previous printing. Therefore, when an error happens before the start of counting, the corresponding total print page count is not recorded, so that precise error history information can not be preserved. Especially, when an error occurs from the start of paper feeding until the start of counting in the printing of a first page, the total print page count has not been counted up remaining 0, thus causing a discrepancy in that a history showing an occurrence of an error before any page is printed, namely when “0 page” has been printed, is stored as an error history information. The above-described configuration solves such a problem effectively. Especially, if an adder unit that adds 1 to total print page count which is acquired from the total print page counting unit is provided in the error history information storage controlling unit, unnecessary error pages are not added to the total print page count recorded in the total print page counting unit (hereinafter, referred to as second total pages), even if, for example, a large number of error pages happened caused by poor maintenance of devices. Therefore, there is no fear of causing a trouble with a lease contract and the like in which the fee is charged per page of print.

An image printing apparatus according to the present invention may be configured such that the type of error is classified into a first type candidate error and a second type fixed error, and the first type candidate error is allowed to be changed in the setting between the first type error and the second type error, and the second type fixed error is set to be fixed to the second type error and cannot be changed.

According to an image printing apparatus with the configuration described above, it is possible to limit errors for which users can choose whether or not to output them. For example, errors such as “NO PAPER ERROR” and “No TRAY ERROR” indicate a lack of paper or the abnormality of print setting, not a printing operation malfunction of device. Thus, it is generally not required to track down causes with reference to error history information. These errors may be set to the second type fixed error in advance, thereby preventing users from accidentally changing the setting of the errors to the first type error.

In an image printing apparatus according to the present invention, at least any one of a service call error, toner-out error, paper jam error, size error which unit that there is no printing paper of a proper size, size mismatch error which unit that a requested paper size is different from a size of paper in a tray, memory full error due to the insufficient print memory and media type error due to the inappropriate media type of printing paper is set as the first type error. Further, at least any one of a cover-open error which unit that a printer cover is stayed open, no-paper error which indicates a run out of printing paper and no-tray error which unit that there is no paper feed tray being requested to feed papers.

The service call error, toner-out error, paper jam error, size error, size mismatch error, memory full error and media type error have possibility that it may be difficult for users to recover from such errors, and thus there is possibility that error history information on such errors might be needed later when one having expertise finds causes. Therefore, it is advantageous to set such errors to be output objections. On the other hand, a cover-open error, no-paper error and no-tray error are easy to recover from errors by users, thus there is basically few advantages in recording them as error history information. Therefore, it is desirable to set such errors in the second type error. Contrarily, if such errors are recorded as history, the first type error is mixed in these errors, with the result that causes of error might be difficult to be tracked down. In addition, only a limited number of errors are stored, so that when, for example, a cover-open error or the like which frequently occurs is stored, the first type error could be inevitably deleted at an early stage. As the result, causes of errors might be difficult to be tracked down.

In an image printing apparatus according to the present invention, the error history information storage controlling unit stores the error history information related to only the first type error in the error history information storing unit, and does not store the error history information related to the second type error.

By this configuration, only the first type error which is required to be displayed as error history information is stored in the error history information storing unit, thereby saving memory capacity.

An image printing apparatus according to the present invention may include the following: an error statistics information storing unit that stores the number of detecting the errors, as an error statistics information, for each of the type of error; an error count counting unit that counts up the number of detecting the first type error detected by the error detecting unit for each of the type of error; an error count acquiring unit that acquires the number of detecting the first type error for each of the type of error from the error count counting unit; an error statistics information storage controlling unit that correlates a type of the detected first type error with the acquired number of detecting errors and stores them as the error statistics information in the error statistics information storing unit; and an error statistics information outputting unit that does not output error statistics information related to the second type error, and outputs only error statistics information of the first type error.

According to an image printing apparatus with the configuration described above, it is possible to output error statistics information that shows the number of error occurrence for each error type in addition to the error history information. Therefore, causes of errors can be easily tracked down by comparing these two pieces of information.

An image printing apparatus according to the present invention may be configured such that the error statistics information storage controlling unit stores the error statistics information related to only the first type error in the error statistics information storing unit, and does not store the error statistics information related to the second type error.

By this configuration, only the first type error which is required to be displayed as error statistics information is stored in the error statistics information storing unit, thereby saving memory capacity.

An image printing apparatus according to the present is invention may include the following: a usage state information storing unit that stores usage state information of the image printing apparatus; a usage state information acquiring unit that acquires the usage state information from the usage state information storing unit; and a usage state information outputting unit that outputs the acquired usage state information.

The above-mentioned usage state information of an image printing apparatus unit information that shows the current usage state of an image printing apparatus, such information including any one of the number of respective trays usage, the number of fuser unit usage, the number of laser light source, the number of drum usage, the amount of toner remaining, the total print page count for each tray, the number of feeding paper for each tray, the number of print pages for each print medium and so on. According to an image printing apparatus with the configuration described above, additionally to the error history information and the error statistics information, the usage state information also can be outputted. Therefore, causes of errors can be easily tracked down by comparing these pieces of information.

An image printing apparatus according to the present invention may be configured such that at least one of the error statistics information outputting unit and the usage state information outputting unit is provided as a subsidiary information outputting unit, in addition to the error history information outputting unit, and an output unit is shared among those outputting unit.

According to an image printing apparatus with the configuration described above, all output information from each output unit can be outputted from one output unit. For example, error history information, error statistics information and usage state information can be outputted from any of a liquid crystal display provided in an apparatus, a display of a personal computer in connection with network and sheet papers printed by a printer. Therefore, it is possible to track down causes of errors based on such output information.

An image printing apparatus according to the present invention may include an output controlling unit that, in addition to the error history, outputs subsidiary information, which is constituted by at least one of the error statistics information and the usage state information, to the output unit at the same time.

In the above description, the simultaneous output unit to output objects onto the same output display or the same printing medium. According to an image printing apparatus with the configuration described above, a plurality of information including at least error history information are simultaneously outputted on the same output display or the same printing medium for investigations of causes of errors, so that it is possible to have a comprehensive overview of them. Therefore, causes of errors can be easily tracked down.

An image printing apparatus according to the present invention may include the following: an output selecting unit that selects one to be outputted, as an output object, from subsidiary information constituted by at least any one of the error statistics information and the usage state information; and an output controlling unit that allows the output unit to alternatively output selected information.

With such a configuration, especially in the case of displaying on an output unit of an image printing apparatus, a display of a personal computer connected with the image printing apparatus or the like, a display screen can be changed optionally to display error history information, error management information and usage state information. Therefore, it is possible to easily track down causes of errors with reference to such information.

The image printing apparatus according to the present invention can be easily realized by installing an error information outputting program in an image printing apparatus through a memory medium.

Hereinafter, illustrative aspects of the present invention will be described with reference to the attached drawings. An image forming apparatus according to an aspect of the invention comprises a counter function for counting print pages (hereinafter, referred to as total print page number) excluding error pages. The total print page number can be associated with details of an error (error type) that the apparatus has detected, to be outputted as error history information. A first type error, which is to be outputted when detected, and a second type error, which is not to be outputted, are set, thereby outputting only the first type error. The image forming apparatus may comprise a printer function, a facsimile function, a scanner function, a copy machine function or the like. This aspect is configured as a printer apparatus 100.

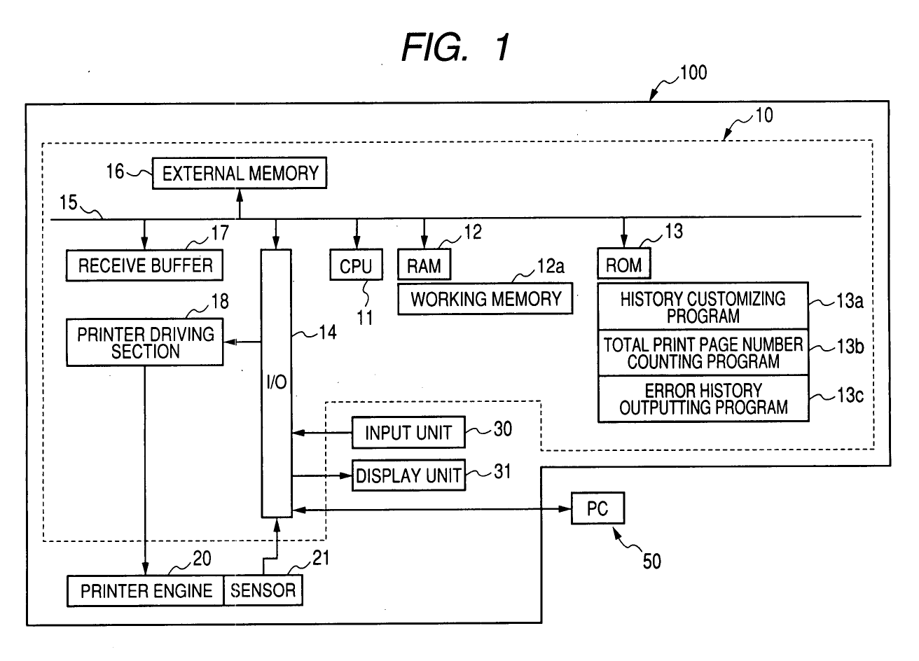

FIG. 1 is a block diagram showing a construction of a printer apparatus serving as an image forming apparatus according to an aspect of the invention. A printer apparatus 100 in FIG. 1 comprises: a printer engine 20 having a well-known structure such as a print system for carrying out printing and a paper-feed system for feeding paper; a sensor 21 that is disposed in each system of the printer and detects errors in printing; input unit 30; display unit 31; and print controlling unit 10 that controls these components.

As shown in FIG. 1, the print controlling unit 10 comprises a CPU 11, RAM 12 having a working memory 12a and the like, ROM 13 that stores various types of programs, I/O 14, bus line 15, external memory 16 comprising nonvolatile memory, receive buffer 17 that temporally buffers image data from the external and printer driving section 18 that drives the printer engine 20. The external memory may be a memory provided inside the printer or a memory card mounted on the printer. The print controlling unit 10 of the illustrative aspect comprises each of an error type determining unit, a total print page number acquiring unit, an error history information storage controlling unit, an error number acquiring unit, an error statistics information storage controlling unit, a usage state information acquiring unit, an adding unit and output controlling unit. In addition, a total print page number counting unit and an error number counting unit comprise a total print page number counting program 13b, which is stored in the ROM 13, CPU 11 and external memory 16. A counter function for counting the total print page number of the printer apparatus 100 and the number of error occurrence for each error type is realized.

The input unit 30 is a group of operating switches comprising a touch switch integrated with the display unit 31, a mechanical switch, and is connected with the print controlling unit 10 through the I/O 14. The input unit 30 forms an error type setting unit together with the print controlling unit 10.

The display unit 31 is a display apparatus such as a liquid crystal display (LCD), and is connected with the print controlling unit 10 through the I/O 14. The display unit 31 serves as an output unit that displays details of an error occurring in the printer apparatus 100. Meanwhile, the output unit may comprise the printer engine (printing unit) 20 capable of printing out on predetermined printing media. The output unit comprises the error history information outputting unit, error statistics information outputting unit and usage state information outputting unit together with the print controlling unit 10.

A personal computer 50 (PC) comprises a CPU, a RAM, a ROM, a hard disk, I/O, an input unit such as a mouse and keyboard, a display unit and a printer driver. The PC is connected with the print controlling unit 10 through the I/O 14. The printer apparatus 100 carries out printing on the basis of a predetermined printing instruction and image data sent from the PC 50. Meanwhile, the PC 50 functions as an input unit similar to the above-described input unit 30 because it has an input unit. The PC 50 also serves as an output unit similar to the above-described display unit 31 because it has a display unit.

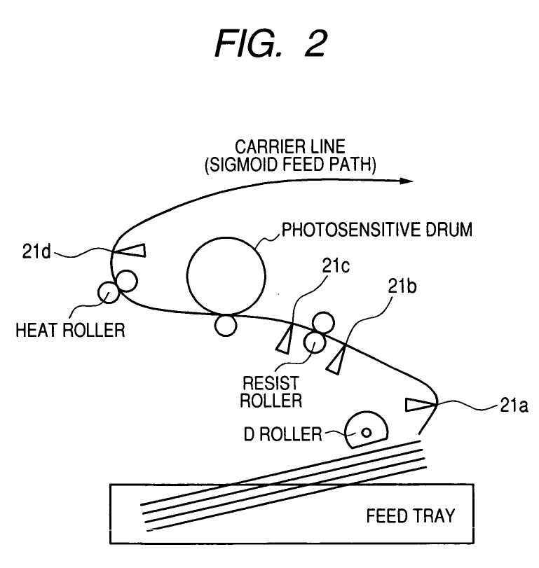

The sensor 21 is a well-known sensor, which is provided at a predetermined point of the printer apparatus 100 comprising the printer engine 20 to detect errors that occurs in the printer apparatus 100. FIG. 2 schematically shows a sheet transporting path. Along the transporting path there are provided: a sheet trailing end sensor 21a that detects a passage of the trailing end of fed sheet; a pre-registration roller sensor 21b and a post-registration roller sensor 21c that detect passage of sheets at the position, each being provided in the upstream side and the downstream side of a registration roller that transports fed sheets to a photosensitive drum while aligning the orientation of sheets; and a sheet discharge sensor 21d that detects passage of sheets, which are transported to a sheet discharge tray after passing through a fixing heat roller. When these sensors 21 (21a to 21d) do not detect passage of sheets even after the lapse of predetermined time from the start of feed, this is recognized as a paper jam error by CPU 11.

Apart from them, the sensor 21 is disposed at a predetermined place in the printer apparatus 100. Also, there are well-known sensors that detects errors in addition to the paper jam error: a service call error; out-of-toner error; size error, which means that there is no sheet of a proper size; size mismatch error, which means that a requested paper size is different from a size of paper in a tray; memory full error due to the insufficient print memory; media type error due to the inappropriate media type of sheet; cover-open error, which means that a printer cover is stayed open; no-paper error, which indicates a run out of sheet; no-tray error, which means that there is no feed tray being requested to feed papers. These sensors 21 detect a specific error, respectively. When an error is detected, the CPU 11 identifies the sensor, which has detected the error, whereby the type of the detected error is identified. The sensors 21 and the print controlling unit 10 function as an error detecting unit.

The printer apparatus 100 described above can correlate an error type detected by the sensors 21 with the cumulative value of the number of print page (total print page number) printed by the printer apparatus 100, and output the resultant as error history information. In addition, by the execution of a history customizing program (error type setting step) stored in the ROM 13, the printer apparatus 100 can categorize plural types of errors being detection objects of the sensors 21 in either of first type errors, which should be outputted, or second type errors, which should not be outputted. Thus, it is possible that error history information related to the second type error that is unnecessary as a history is not outputted, and that only error history information related to the first type error, which is necessary as a history, is outputted.

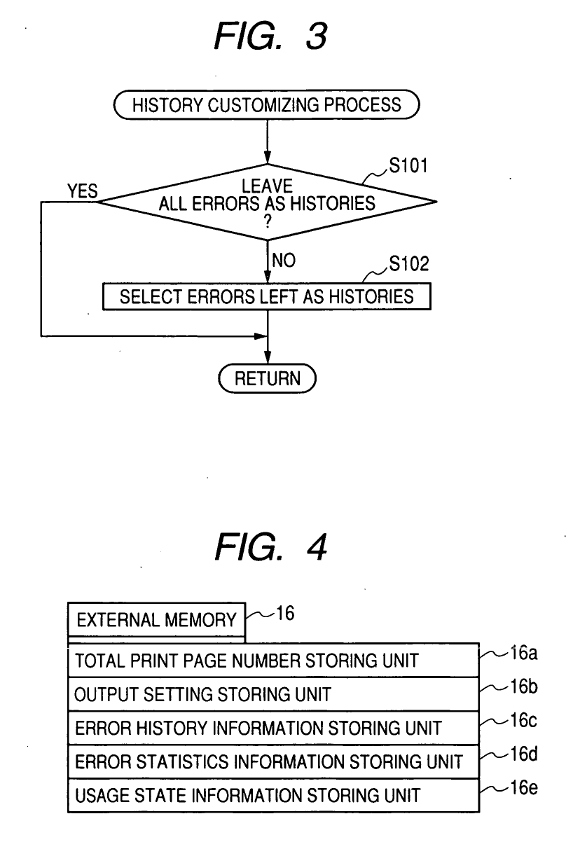

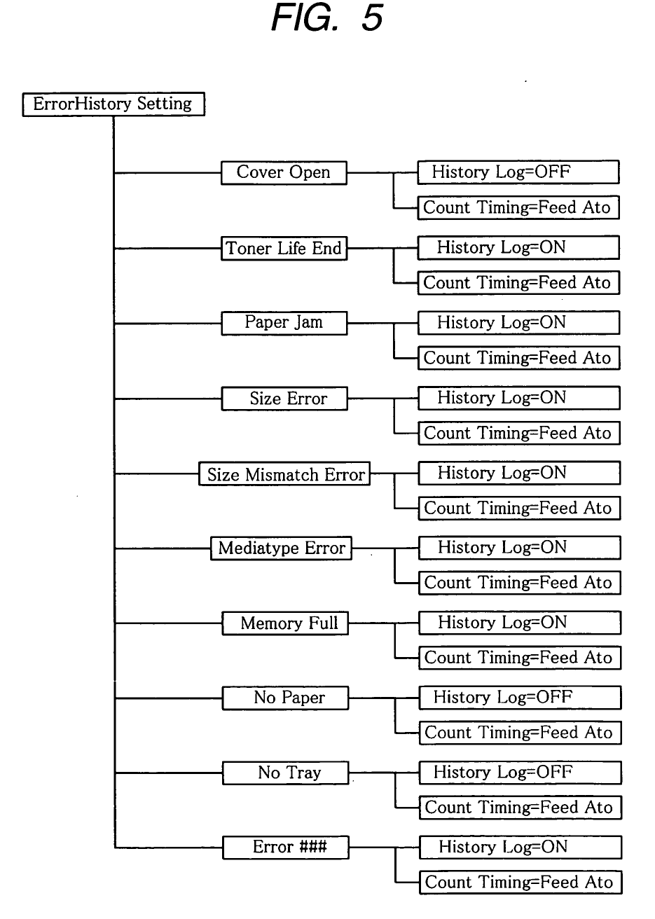

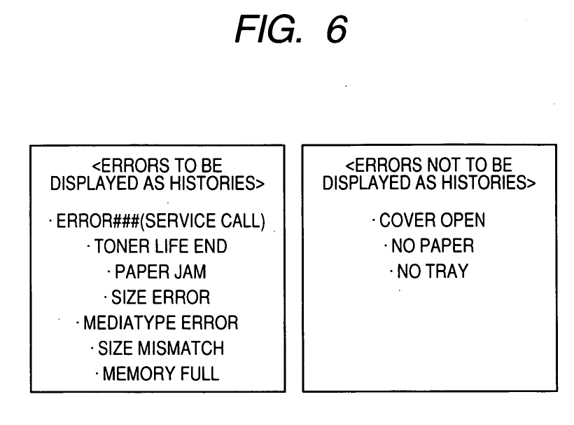

FIG. 3 is a flow chart showing the flow of the history customizing program 13a. The history customizing program 13a performs a selection of not leaving all errors as a history in S101 by a predetermined input operation from the input unit of the printer apparatus 100 or from an input unit of the PC 50 connected therewith. That is, it is selected that only necessary ones among errors detected will be left as a history. Then, in S102 output setting for setting an error type to be outputted and an error type not to be outputted is customized, and the customized output setting is stored in an output setting storing unit 16b (See FIG. 4) of the external memory 16. Here, a screen as shown in FIG. 5 is displayed on a liquid crystal display serving as the output unit 30 of the printer apparatus 100 or on a display serving as an output unit of the PC 50 connected therewith. A setting is defined as error histories are outputted when “History Log” is “ON”, and as error histories are not outputted when “History Log” is “OFF”. In the case that “History Log” is set “ON”, an output setting flag of the error type for which “ON” has been designated is set. As shown in FIG. 6, it can be seen in the setting status in FIG. 5 that “ERROR###” (service call error), “TONER LIFE END”(out-of-toner error), “PAPER JAM” (paper jam error), “SIZE ERROR” (size error), “SIZE MISMATCH ERROR” (size mismatch error), “MEMORY FULL” (memory full error) and “MEDIA TYPE ERROR” (media type error) are set as the first type error, which should be left as error history information. It can be also seen that “COVER OPEN” (cover open error), “NO PAPER” (no paper error) and “NO TRAY” (no tray error) are set as the second type error, which should not be left as error history information. Meanwhile, errors with which output setting can be done are not limited to the error types described above, and may be different types of errors from those which can be detected by the printer apparatus 100.

It is not necessary that the output setting of error history information be enabled for all error types. A first type candidate error for which the output setting can be changed, and a second type fixed error for which the output setting can not be changed and which is fixed as the second type error in advance, may be defined. For example, “NO PAPER” (no paper error) and “NO TRAY” (no tray error) shown in FIG. 5 may be set as the second type fixed error, and the others may be set as the first type candidate error. Such errors as “NO PAPER” (no paper error) and “NO TRAY” (no tray error) indicate a run out of paper and an abnormal setting, not a printing operation malfunction, and thus they are hardly referred to when left as a history. Contrarily, when such errors are shown, it becomes difficult to find the other errors. Therefore, it is preferable to preliminarily set them as the second type fixed error in order to prevent users from mistakenly changing the setting. Further, a first type fixed error for which the output setting cannot be changed and which is fixed as a first type error in advance may be defined. In this case, it is possible to disable users to change the output setting with regard only to error types, which the manufacturer wishes to surely leave for determination of the cause of error. In this way, it becomes possible to certainly leave minimum error histories in the apparatus. Moreover, it is also possible to leave the output setting of all errors changeable and make a separation between the first type error and the second type error as a default setting in advance. In this case, when “ON”/“OFF” conditions reflecting opinions of service persons who provide service or maintenance are set as a default setting, users are more likely to use the apparatus based on the default setting, which a manufacturer decides. With such a setting provided in advance, a service person or the like having expertise can easily find error information indicating the cause of error when looking into error history information in a future error release operation, so that the cause of error can be found more easily.

The printer apparatus 100 counts the total print page number by executing a total print page number counting program 13b stored in the ROM 13. When an error happens, the printer apparatus 100 changes the total print page number into an appropriate value, then correlates the number with the type of the error, which has happened, and stores the resultant as error history information.

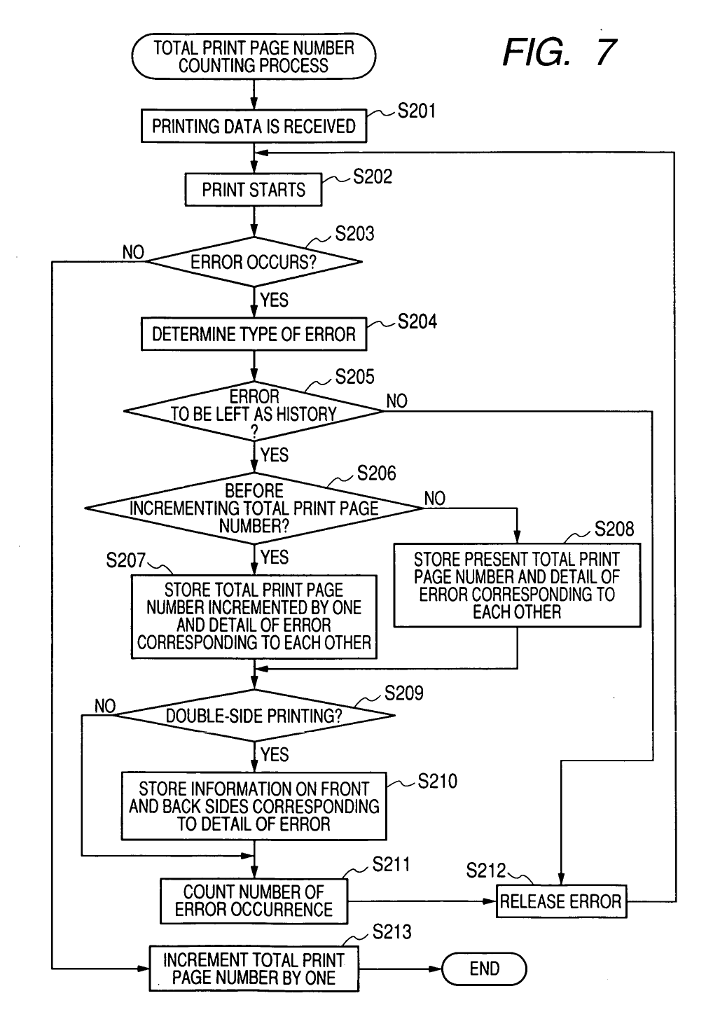

FIG. 7 is a flow chart showing the flow of the total print page number counting program 13b. In total print page number counting program 13b, in S201 to begin with, a page of image data for print is received from the PC 50 and then is stored temporally in the receive buffer 17. In S202 the printer driving section 28 sends the printing data based on the temporally stored image data to the printer engine 20 and then starts printing.

In 203 the presence or absence of the occurrence of errors is detected through each processing after the start of printing (error detecting step). The error detection is carried out by the respective sensors 21 and the CPU 11. When no error has been detected, the command proceeds to S213.

In S213, on the basis of the detection of the passage of sheet by the sheet discharge sensor 21d (See FIG. 2), the total print page number stored in a total print page number storing unit 16a of the external memory 16 in FIG. 4 is acquired first. Then, the acquired value is incremented by one, and the sum is overwritten on the total print page number storing unit 16a (total print page number acquiring step and total print page number counting step). Subsequently, the print processing of the page is completed.

When an error has been detected in S203, the command proceeds to S204, where the error type is identified. As described above, the CPU 11 receives an error detection signal from a specific sensor of the sensors 21, and on the basis of the determination of the specific sensor, it identifies the type of the error. Next in S205, on the basis of output setting information stored in the output setting storing unit 16b, the CPU 11 determines whether the error belongs to the first type error to be outputted or to the second type error not to be outputted (error type determining step). The CPU 11 determines whether or not an output setting flag of the identified error type is set in the output setting storing unit 16b, whereby the error type determining step is carried out. When the error type is the second type error, which should not be outputted, the command proceeds to S212, and after error release, returns to S202, where the print processing is restarted. When the error type is the first type error, which should be outputted, the command proceeds to S206.

In S206 it is determined whether or not the page being printed has been added up, during the print processing of the page, to the present total print page number stored in the total print page number storing unit 16a for the period from the start of the feed to the occurrence of the error. This can be determined, for example, when the total print page number right after the start of the print processing in S202 is stored in a predetermined region of the RAM 12, and the CPU 11 compares the value with the present total print page number.

When the page being printed has not been added up to the total print page number in S206, the command proceeds to S207. In this case, the present total print page number stored in the total print page number storing unit 16a is acquired, then incremented by one. The value given incremented by one is associated with the type of the error, which has occurred, in such a fashion as shown in FIG. 9, and it is stored as error history information in the error history information storing unit 16c (total print page number acquiring step and total print page number counting step). After the storage is finished, the command proceeds to S209.

When the page being printed has been added up to the total print page number in S206, the command proceeds to S208. In this case, the present total print page number stored in the total print page number storing unit 16a is acquired, the value given is associated with the type of the error, which has occurred, in such a fashion as shown in FIG. 9, and it is stored as error history information in the error history information storing unit 16c (total print page number acquiring step and total print page number counting step). After the storage is finished, the command proceeds to S209. Meanwhile, in S207 and S208, the number of error types stored as histories in the error history information storing unit 16c is up to ten in this illustrative aspect. In the case that the number exceeds ten, the error type histories are deleted in the order from the oldest to the newest.

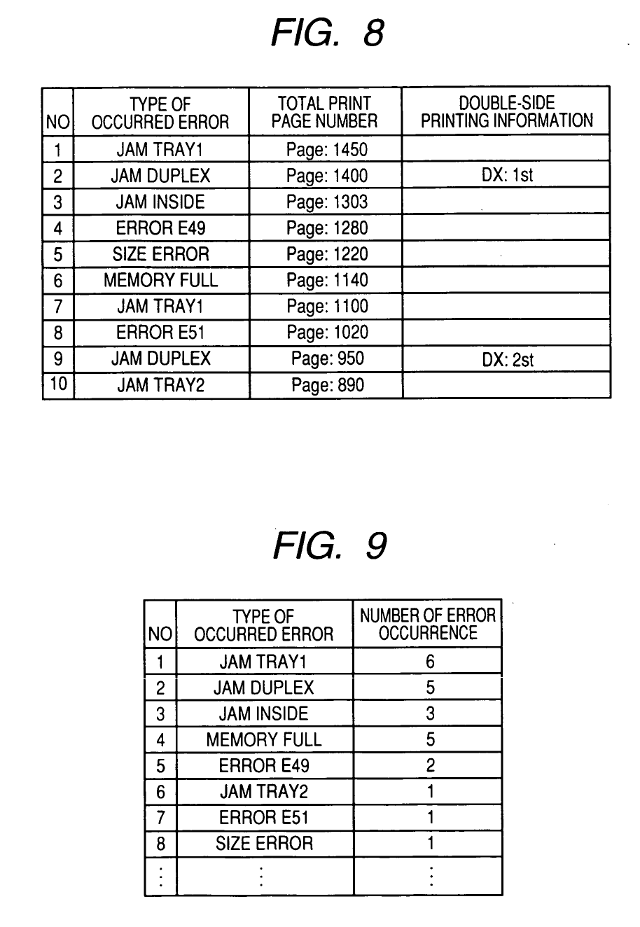

In S209 it is determined whether or not the printing is a double-side printing. In the double-side printing, the print processing is discriminated between the surface side and the back side. Each print processing of the surface and back sides is counted up. The total print page number is incremented by one right after each print processing. When the printing is determined to be a double-side printing in S209, the command proceeds to S210, where double-side printing information that the printing is a surface side printing or that the printing is a back side printing is associated with the type of the error, which has occurred, and it is stored in the error history information storing unit 16c as shown in FIG. 8. The command proceeds to S211. In the case that the printing is not determined to be a double side printing, the command proceeds to S211.

In S211, as shown in FIG. 9, among the numbers of error occurrence for each error type stored in an error statistics information storing unit 16b, the number of error occurrence for the type of the error, which has occurred, is acquired. The acquired value is incremented by one. The value given additional one is overwritten on the error statistics information storing unit 16b. By this step, error statistics information is updated.

After this step, in the case that the error having happened is recovered in S212, the command returns to S202, where the printing is restarted. The commands are repeated until the print processing is normally completed. Meanwhile, in the case that an error has happened during a double-side printing, when the error has happened in the second printing processing of the print processing of the both sides, the present total print page number stored in the total print page number storing unit 16a is decremented by one after the error release in S212. In S202 the print processing is restarted from the first page.

In the total print page number counting program 13b, only error history information and error statistics information each being related to the first type error is stored in the external memory 16. Information related to the second type error is not stored. Therefore, it is possible to save the capacity of the external memory 16, thus cutting down on costs. Meanwhile, when the external memory can be used without concern about the memory capacity, such a configuration as all of the error history information and error statistics information each being related to the second type error may be employed.

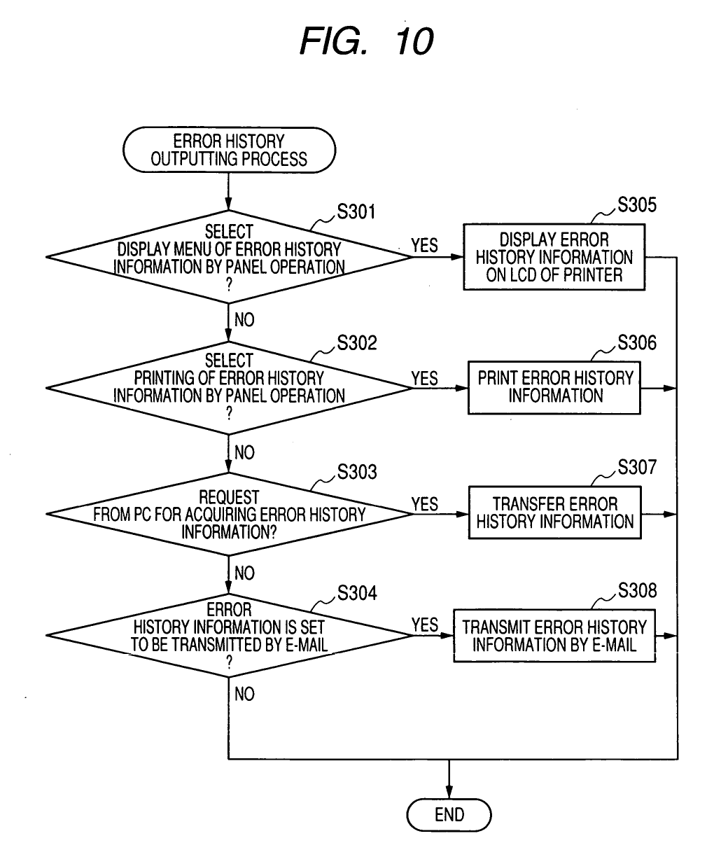

Such error information on the first type error stored in the external memory 16 can be outputted by executing an error history outputting program 13c (error history information outputting step). FIG. 10 is a flow chart showing the flow of the error history outputting program 13c. In the error history outputting program 13c, in S301 to begin with, it is determined whether or not there is a request for screen display of error history information. This request is determined based on whether or not the display menu of error history information has been selected through the operation of the touch switch provided in a liquid crystal display (display panel) of the printer apparatus. In the case that the menu has been selected, the command proceeds to S305, where the error history information is displayed on the liquid crystal display of the printer apparatus 100. In the case that the menu has not been selected, the command proceeds to S302. In S302 it is determined whether or not the printing of error history information has been selected likewise through the operation of the touch switch. In the case that the printing has been selected, the command proceeds to S306, where the error history is printed out by the printer engine 20 of the printer apparatus 100. In the case that the printing has not been selected, the command proceeds to S303. In S303 it is determined whether or not there has been a request from the PC 50 for acquiring error information. In the case that there has been a request, the command proceeds to S307, where error history information is transferred to the PC 50. In the case that there is no request, the command proceeds to S304. In S304 it is determined whether or not the setting of the printer apparatus 100 is set such that error history information be automatically transmitted by e-mail. In the case that the setting is set to automatic transmission, the command proceeds to S308, where the error history information is transmitted to a predetermined address by e-mail.

Information outputted as described above is not limited to error history information, and the above-mentioned error statistics information can be also outputted. In addition to such information, usage state information of the printer apparatus may be outputted. The usage state information is information that indicates the present usage state of the printer apparatus. The usage state information may comprise the usage frequency of each tray, the usage frequency of the fuser unit comprising a fuser roller and the like, the usage frequency of the laser light source, the usage frequency of the drum, life information of consumables such as the amount of toner remaining, the total print page number for each tray, the number of feed of each feed tray, print information related to the total print page number such as the number of print pages of each printed media type, the number of replacing the other consumables and so on.

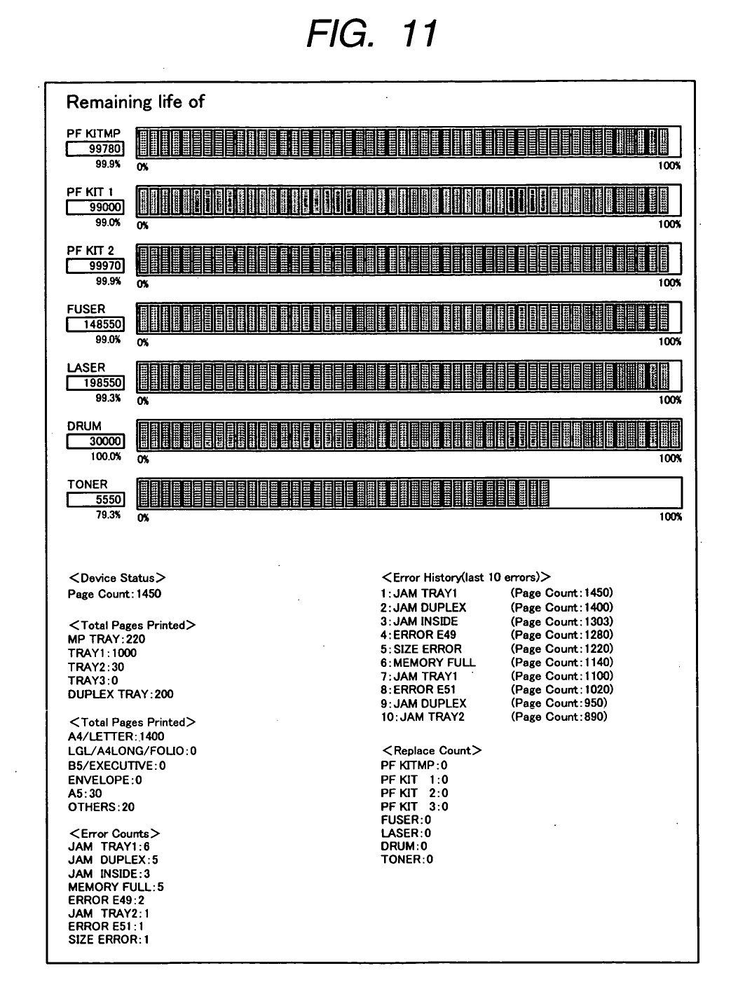

As concrete output forms of information described above, for example, as shown in FIG. 11, there is a way to output error history information, error statistics information and usage state information on a display screen or a sheet at the same time. In FIG. 11 the upper strip-shaped graph shows the life information of consumables; <Device Status> shows the total print page number; <Total Pages Printed> shows print information related to the total print page number; <Error Counts> shows error statistics information; <Error History (last 10 errors)> shows error history information on a predetermined number of (for example, 10) errors in reverse chronologic order from the latest; and <Replace Count> shows the replace count of consumables. Accordingly, not only error history information, but also error statistics information and usage state information are displayed on the same screen, or printed out on the same sheet, whereby it becomes possible to judge the cause of error from plural pieces of information.

The output forms are not limited to those shown in FIG. 11. At least, all that is required is that error history information is displayed whatever the form is. In addition, a form in which at least any one of error management information and usage state information is outputted at the same time may be employed. Further, it is also possible to select information to be outputted among the above-described information by means of the input from the input unit 30 and then output the selected information on a screen alternatively. For example, the system may be configured such that the displays of error history information, error statistics information and usage state information are switched on a liquid crystal display by the print controlling unit 10 on the basis of a predetermined input of the input unit 30 such as the input operation of a touch switch (input unit 30) of a liquid crystal display (display unit 31).

Although illustrative aspects of the present invention are described above, they are mere exemplifications and are thus not intended to limit an aspect of the invention. Various combinations and modifications of the preferred illustrative aspects could be made based on the knowledge of those skilled in the art without departing from the scope of an aspect of the invention. For example, as the total pages, a cumulative value of the number of print pages counted at every print processing may be used. In this case, it is possible to set error types, which are to be left as error history information, and it is also possible to store and output error history information for each print processing. Further, as the total print page number, any of a first total print page number to which all errors having occurred in the same page are counted up as the same page and a second total print page number to which errors having occurred in the same page are cumulatively counted up may be used.

A total print page number counting unit, which counts the first total print page number is defined as a first total print. page number counting unit. By using the first total print page number counting unit, errors having occurred in the same page are represented as the same page in error history information to be outputted, so that errors having occurred in the same page can be easily discriminated from those of the other pages. Errors having repeatedly occurred in the same page may be stored and outputted such that the chronologic order can be identified, for example, by displaying errors as (Page Count: 1450-1), (Page Count: 1450-2) . . . in a chronologic order. The first total print page number counted by the first total print page number counting unit can be used for charge calculation, for example, when the image forming apparatus is one for lease. For lease products, the fee is calculated on the basis of print fee per page and the total print page number. In this case, it is however undesirable that error pages are counted as charging objects. Thus, in an image forming apparatus with the first total print page number counting unit, not only can the first total print page number counted be used in the error history information according to the present information, but also it is used for charge calculation of a lease contract.

A total print page number counting unit, which counts the second total print page number, is defined as a second total print page number counting unit. By using the second total print page number counting unit, second total print page number and errors having occurred are displayed such that both of them are associated. Therefore, it becomes easy to understand the relationship between the time degradation, which occurs in the image forming apparatus and errors having occurred. Meanwhile, the second total print page number counting unit may comprise a count displaying unit that displays the second total print page number counted, whereby it would become possible to check a present second total print page number, that is, all print pages counted with error pages. Accordingly, users or service persons can check the displayed result at the time of occurrence of an error or maintenance, thereby helping to find the cause of error or to do maintenance.

The first total print page number counting unit and the second total print page number counting unit may be provided at the same time. In this case, the total print page number storing unit 16a in FIG. 4 may comprise a first total print page number storing unit that stores a first total print page number and a second total print page number storing unit that stores a second total print page number, store the first total print page number counted by the first total print page number counting unit as error history information, and display the second total print page number counted by the second total print page number counting unit on the count display unit separately provided. Accordingly, error history information in which there is a clear discrimination between errors having successively occurred in the same page and errors having occurred in the other pages can be outputted. Further, the present second total print page number can be checked by viewing a display on the count display unit. Thus, it becomes possible to determine whether or not errors having occurred are ascribable to the time degradation of the apparatus.

Although the counting of total print page number in a normal printing may be carried out after feed as in the illustrative aspect, it may be also carried out before feed, that is, at the same time as the start of printing. Moreover, for example, with a screen displayed as shown in FIG. 5, <Count Timing> on the screen is to be selected between <Feed ATO> and <Feed MAE>. When the <Count Timing> is set to <Feed ATO>, the counting is carried out at a predetermined timing after feed as in the illustrative aspect. When it is set to <Feed MAE>, the counting is done at the same time as the start of printing. With such a configuration, the timing of counting the total print page number may be allowed to be selected by users.

What is claimed is:

1. An image forming apparatus comprising:
an error history information storing unit that stores error history information generated in a printing processing;
an error history information outputting unit that outputs the error history information;
an error detecting unit that detects an error, which occurs in the image forming apparatus;
an error type determining unit that determines whether an error detected by the error detecting unit belongs to the first type error or the second type error;
a total print page number counting unit that counts a total print page number in the image forming apparatus; and
a total print page number acquiring unit that acquires the total print page number from the total print page number counting unit,
wherein
the error history information outputting unit does not output error history information associated with the second type error, and outputs error history information of the first type error.

2. The image forming apparatus according to claim 1, further comprising:
an error type setting unit that categorizes a plurality of errors to be detected by the error detecting unit into a first type error to be outputted by the error history information outputting unit or into a second type error not to be outputted by the error history information outputting unit, wherein
the error type determining unit determines whether the error detected by the error detecting unit belongs to the first type error or the second type error with reference to a setting set by the error type setting unit.

3. The image forming apparatus according to claim 1, wherein
the total print page number acquiring unit acquires the total print page number from the total print page number counting unit in a case where the first type error is detected.

4. The image forming apparatus according to claim 1, further comprising:
an error history information storage controlling unit that associates the detected category of the first type error with the acquired total print page number, and stores as error history information in the error history information storing unit, wherein
the error history information outputting unit outputs error history information of the first type error and the total print page number associated with the first type error.

5. The image forming apparatus according to claim 1, wherein
the total print page number counting unit counts the total print page number after a starting of a feeding process, and
in a case where the first type error occurs between the starting of the feed process and the counting of the total print page number counting unit, the error history information storage controlling unit stores a counted value of the total print page number incremented by one and the first type error associated with each other, in the error history information storing unit.

6. The image forming apparatus according to claim 5, wherein
the error history information storage controlling unit comprises an adder unit that increments the total print page number acquired from the total print page number counting unit by one.

7. The image forming apparatus according to claim 1, wherein
the category of error is classified into a first type candidate error and a second type fixed error,
the first type candidate error is allowed to be changed in setting between the first type error and the second type error, and
the second type fixed error is set to be fixed to the second type error and cannot be changed.

8. The image forming apparatus according to claim 1, wherein
the first type error is set to at least any one of a service call error, out-of-toner error, paper jam error, size error, which represents that there is no sheet of a proper size, size mismatch error, which represents that a requested size is different from a sheet size in a tray, memory full error due to insufficient print memory and media type error due to inappropriate media type of sheet, and
at least any one of a cover-open error, which represents that a printer cover is stayed open, no-paper error, which indicates a run out of sheet and no-tray error, which represents that there is no feed tray being requested to feed papers.

9. The image forming apparatus according to claim 1, wherein
the error history information storage controlling unit stores only the error history information with respect to only the first type error in the error history information storing unit, and does not store the error history information with respect to the second type error.

10. The image forming apparatus according to claim 1, further comprising:
an error statistics information storing unit that stores a number of detecting the errors, as error statistics information, for each category of error;
an error statistics information storage controlling unit that associates a category of the detected first type error with the acquired number of detecting errors, and stores as the error statistics information in the error statistics information storing unit; and
an error statistics information outputting unit that does not output error statistics information with respect to the second type error, and outputs only error statistics information with respect to the first type error.)

11. The image forming apparatus according to claim 10, wherein
the error statistics information storage controlling unit stores only the error statistics information with respect to the first type error in the error statistics information storing unit, and does not store the error statistics information with respect to the second type error.

12. The image forming apparatus according to claim 1, further comprising:
a usage state information storing unit that stores usage state information of the image forming apparatus;
a usage state information acquiring unit that acquires the usage state information from the usage state information storing unit; and
a usage state information outputting unit that outputs the acquired usage state information.

13. The image forming apparatus according to claim 12, wherein
at least one of the error statistics information outputting unit and the usage state information outputting unit is provided as a subsidiary information outputting unit, and
an output unit is shared between the subsidiary information outputting unit and the error history information outputting unit.

14. The image forming apparatus according to claim 13, further comprising:
an output controlling unit that outputs subsidiary information and the error history to the output unit at the same time, the subsidiary information comprising at least one of the error statistics information and the usage state information.

15. The image forming apparatus according to claim 13, further comprising:
an output selecting unit that selects information, as an output object, from subsidiary information comprising at least any one of the error statistics information and the usage state information; and
an output controlling unit that allows the output unit to alternatively output the selected information.

16. A computer program product for enabling a computer to output error information of an image forming apparatus comprising an error history information storing unit that stores error history information generated in a printing processing, and an error history information outputting unit that outputs the error history information, comprising:
software instructions for enabling the computer to perform predetermined operations, and
a computer readable medium bearing the software instructions;
the predetermined operations comprising the steps of:
detecting an error by an error detecting unit, the error occurring in the image forming apparatus;
determining by an error type determining unit whether an error detected by the error detecting unit belongs to the first type error or the second type error;
counting a total print page number in the image forming apparatus by a total print page number counting unit;
acquiring the total print page number from the total print page number counting unit by a total print page number acquiring unit; and
not outputting error history information associated with the second type error and outputting only error history information of the first type error by the error history information outputting unit.
